(19) United States
(12) Patent Application Publication
(10) Pub. No.: US 2025/0037530 A1
(43) Pub. Date: Jan. 30, 2025

(54) AUTOMATIC VENDING MACHINE LIFT AND AUTOMATIC VENDING MACHINE

(71) Applicant: JOFEMAR, S. A., Navarra (ES)

(72) Inventor: Jesus GUINDULAIN BUSTO, Navarra (ES)

(21) Appl. No.: 18/782,977

(22) Filed: Jul. 24, 2024

(30) Foreign Application Priority Data
Jul. 28, 2023 (EP) 23382789.8

(51) Int. Cl. G07F 11/38

(52) U.S. Cl. CPC G07F 11/38

(57) ABSTRACT

The object of the invention is an automatic vending machine lift that makes it possible to dispense products from a surface arranged at the same height as the access door to the inside of the lift, so that the product is visible in its entirety before and during extraction, where the product does not need to be raised therein to remove it from the machine, but only dragged in a horizontal direction.

### OBJECT OF THE INVENTION

The object of the invention is an automatic vending machine lift that makes it possible to dispense products from a surface arranged at the same height as the access door to the inside of the lift, so that the product is visible in its entirety before and during extraction, where the product does not need to be raised in the lift to remove it from the machine, but only dragged in a horizontal direction.

The invention also relates to the automatic vending machine comprising said lift.

### BACKGROUND OF THE INVENTION

There are different automatic machines on the market for dispensing all types of products, said machines provided with a lift that will collect the product to the tray where it is stored in order to prevent, as much as possible, the product from being struck during dispensing, so that once the product is in the lift, it is positioned with respect to an outlet in order to be removed by the customer.

This outlet may be positioned laterally with respect to the lift or it may give direct access to the lift itself and be removed directly from same by the customer from an opening in the front part of the machine. Among the foregoing is European patent application EP2704111A1 relating to an automatic vending machine that comprises a front part that has a rotatable collection door for collecting the products dispensed by the machine, a frame and a lift which both collects a certain product arranged on a certain tray of the machine and moves the product to a collection bin accessible through the rotatable collection door where the lift comprises a rotatable top lid that allows the rotational shaft of the product collection door to be arranged at a greater height than the top lid of the lift.

This system presents a series of drawbacks and physical limitations that determine the size of the products to be dispensed and the storage capacity in the tray area, and it also causes incidents that block the entire machine due to defective replacement of the product on the trays or due to acts of vandalism that can leave the machine out of service.

The ceiling of the lift constitutes a security system to prevent machine users from accessing the storage area when the lift is placed in its product collection position, at which time there is free access to the inside of the lift, but in no case should access be allowed through the lift to the storage area where the trays are located, thus limiting the possibility of theft.

The objective of product dispensing machines of this type is to ensure that the size of the products to be dispensed is as large as possible and that once the product is inside the same, the product does not collide either with the storage trays or with the door mechanisms during their upward or downward movement, so that the lift can reach its product delivery position without interference.

These lifts have a U-shape, so that the two vertical faces of the “U” seek to prevent the products in the upward or downward movement from colliding with the trays or the door mechanisms. These vertical faces can have different heights, but they require the lift to stop with respect to the product collection door at a certain height, so that the upper edge of the vertical wall is below the lower end of the collection door, so that the product to be removed has to be picked up by the customer and raised with respect to the bottom of the lift in which it is located until it exceeds the height of the upper edge of the vertical wall. This often means that the product cannot be seen with the naked eye and has to be searched for blindly with a hand, it has to be raised and rotated to be extracted through the product collection door and, therefore, the maximum size of the product to be dispensed is limited by the size of the door and by the diagonal dimension of the product that has to be rotated for extraction, resulting in a very uncomfortable operation for the customer.

These U-shaped vertical walls and the distance from the upper edge of the same to the ceiling are what define the maximum height of the product to be dispensed since the product reaches the lift by passing through said space, so that the total size of the lift will be defined by the height of the vertical wall plus the distance to the ceiling.

The greater the height of the vertical edge of the “U”, the greater the security and the larger the products that can be dispensed without causing blockages due to collision during the movement of the lift. The greater the distance between the upper edge of the “U” and the ceiling, the larger the product to be dispensed, but at the same time the size of the lift in height will be greater, negatively affecting the useful storage measure. Given this physical configuration of the lifts, a total lift height must always be much higher than the height measurement of the largest product that is to be dispensed.

Furthermore, in many of the known vending machines, the lift is a system balanced by a pulley and a counterweight on the opposite side that keeps the system stable, so that the weight of the product it dispenses when falling on same causes an imbalance, which can become a problem when the dispensed product is very heavy and causes the lift to lower due to differences in weight, even making it impossible to dispense a second time because the lift loses its relative position with respect to the storage tray.

Furthermore, the external height of vending machines is defined by a standard that manufacturers must meet, so that, by complying with these measurement standards, and depending on the dimensions of the different mechanisms, each manufacturer is able to have a greater or lesser number of trays in height in the machine. Normally, the products are arranged inside the trays in a vertical position to obtain a perfect view of them while they are stored and in a certain way to be displayed for sale. Therefore, the number of trays that can be placed at a height also depends on the height of the stored products, but in addition and perhaps more important, the number of trays also depends on the total height dimension of the lift as indicated previously, since the height space in which the trays can be placed is a specific physical space, but the height at which the upper tray can be placed within this physical space is limited by the external height of the lift, since the lift must be placed facing the tray in a position defined by detection means for detecting the position of both mechanisms in which it is ensured that the products pass through the gap defined between the lower face of the lift ceiling and the upper edge of the vertical wall of the “U”.

Likewise, the external height of the lift defines the minimum height at which the lower tray can be placed, since the trays, to be reloaded, must be able to move outwards to reload their storage channels without physically interfering with the lift, which, in its reloading position, is positioned at the bottom of the machine to allow reloading of the trays.

Last but not least, the lift can become blocked when, in its upward movement, it collides with a product that has been poorly stored on the trays or that, as a result of a previous extraction, has been left protruding from its storage area. In this situation, the lift collides with the product and said product ends up on top of the lift's ceiling until it is removed by a technician. In this situation, if the lift has to go to the highest storage tray to position itself with respect to the same, making the lift position detection means coincide with the corresponding detection means that are on the tray, it cannot reach this position because the product placed on the lift's ceiling collides with the machine's ceiling before the detection means face each other, leaving the dispensing of this last tray out of service. On other occasions, the product that has remained on top of the lift's ceiling collides with the storage trays in its upward movement, preventing its upward movement and therefore blocking the machine in its entirety. On other occasions, as a result of acts of vandalism, the machines are struck or moved forcefully, intending for the products to fall from their storage area, and they end up on the ceiling thereof, producing the same effect mentioned above.

The automatic vending machine lift of the present invention solves all of the aforementioned drawbacks.

### DESCRIPTION OF THE INVENTION

The present invention relates to an automatic vending machine lift, wherein the automatic vending machine comprises a set of storage trays arranged at different heights where the products to be dispensed are arranged and a front wall comprising a product collection door that in turn it comprises a lower edge.

The lift comprises a platform for collecting the products coming from the storage trays, an upper part, and a movable wall configured to position itself, at least partially, between a first position in which the movable wall, in use, allows a product to pass from a storage tray to the product collection platform, and a second position in which the movable wall, in use, allows the product to pass from the product collection platform to the outside of the automatic vending machine and blocks access to at least the storage trays from inside the lift.

Preferably, the movable wall is a wall that can adapt to different locations. More preferably, the movable wall is a movable wall made of slats joined together.

In this way, the lift thus constituted allows the products to be dispensed from a surface arranged essentially at the same height as a lower edge of the collection door for the products arranged inside the lift in order to collect them, so that the product is visible in its entirety before and during extraction, where the user is not required to raise the product inside the lift when removing it from the machine, but only move it in a horizontal direction, in addition to preventing unwanted access to the inside of the machine from the lift.

Optionally, the movable wall of the lift is also configured to be positioned in a third position in which the movable wall, in use, at least partially separates the inside of the lift from the storage trays and from the front wall of the machine, to thus prevent the product arranged on the product collection platform of the lift from colliding with the other products stored on the trays, and with the front wall of the machine.

Optionally, the movable wall of the lift is configured, in the first position, to separate the lift from the front wall of the machine, and to thus prevent the product passing from the storage tray to the lift from colliding with the front wall of the machine.

Optionally, the movable wall of the lift is configured, in the second position, to block access to the inside of the machine through the upper part of the lift.

Optionally, the product collection door comprises a lower edge, where the product collection platform is arranged at the same height or above the lower edge of the product collection door in the second position of the movable wall.

Optionally, the third position of the movable wall of the lift is an intermediate position between the first position and the second position.

Optionally, the movable wall of the lift can be moved from the first position to the second position, or vice versa, that is, from the second position to the first position, below the product collection platform, preferably through the third position. In this way, the movable wall can be moved with the product already located on the product collection platform, since at no time does the movable wall come into contact with said product.

Optionally, the lift comprises first drive means configured to move the movable wall at least between the first position and the second position, and/or vice versa. Preferably, the first drive means are configured to move the movable wall between the first position and the second position, passing through the third position, and/or vice versa.

Optionally, the lift comprises second drive means configured to move the lift in an upward and downward direction with respect to the storage trays.

Optionally, the lift comprises blocking means configured to block and unblock the first drive means and/or the second drive means, thus being able to independently or jointly block/unblock the movable wall and the upward and downward movement of the lift itself.

Optionally, the lift comprises first detection means for detecting the presence of the product on the product collection platform, which makes it possible to determine that the product has reached the product collection platform of the lift and that it is located on the same, whereby the extractor performing the dispensing can be controlled, for example by stopping it, and furthermore, when the product collection door is open during removal by the user, it allows checking until the moment the product is on the product collection platform, to proceed to close the product collection door and thus end the sale.

Optionally, the lift comprises second detection means for detecting the presence of the product on the product collection platform, which makes it possible to determine whether the product, during dispensing from the storage tray, has fallen on the product collection platform of the lift, whereby the extractor performing the dispensing can be controlled, for example by stopping it, and makes it possible to determine whether the product is still visible by the second detection means, whether the product is large in size and whether it is impossible to perform multiple dispensing, or whether the product is not visible by the second detection means, whether the product is small in size and whether it is possible to perform multiple dispensing without moving the lift to the product collection door.

Optionally, the storage platform of the lift can be moved horizontally in the second position, towards the outside of the machine, to facilitate the collection of the product or products by the user. This operation will be carried out once the product collection door has been opened, which will be described below.

The invention also relates to an automatic vending machine that comprises the lift described above, a set of storage trays arranged at different heights where the products to be dispensed are arranged and a front wall that comprises a product collection door that in turn comprises a lower edge.

Optionally, the product collection door can be moved vertically, preferably downwards, and preferably also horizontally towards the lift, occupying the space that is not occupied by the movable wall in the second position. It can also be transparent. In this way, a perfect view of the products displayed in the front part of the machine, preferably transparent, is achieved even during a sale since the product collection door is descending and does not produce reflections since the product collection door does not overlap the front part of the machine. Likewise, since it is descending, the user's hands can never be trapped in said movement. Another advantage of the product collection door being descending is that the collection door itself continues to hold the products until almost the end of its opening, allowing the product to be removed before the opening door has completely opened. If it were ascending, the round products could fall as soon as the product collection door had reached the height of the product without the user being able to reach in to pick it up due to the lack of space for inserting their hand.

With the machine configured in this way, the product does not have to be rotated, since the maximum dimension of the product to be extracted is not limited by the measurement of the height dimension of the product collection door or by the diagonal of the product, but rather by the actual height of the product.

Optionally, the machine further comprises blocking means configured to block the closing of the product collection door. Also due to the presence of the first detection means in the lift, the presence of any object or part of the user's body, such as a hand, will be detected and the blocking means will block the rise of the door until the detection means cease to detect said object or part of the user's body.

Optionally, the machine comprises detection means arranged on each of the storage trays, which detect the position of third detection means of the lift, to determine that the lift is in the desired position with respect to the storage trays.

Optionally, the machine comprises security means that stop the product collection door from closing in the event that the blocking means malfunction, and thus prevent entrapment from occurring.

Optionally, the lift comprises a control system that controls all the elements and means described above.

In short, the lift and the automatic vending machine of the present invention have the following advantages:
Smaller lift size, to remove a large product.
Shorter fall distance of the product to the lift (position 1 of the movable wall).
Product delivery at an ergonomic height, fully visible and therefore more comfortable in which the user only has to move the product (position 2 of the movable wall).
Possibility of recording with a camera the extraction of storage trays to the lift (position 1 of the movable wall).
The possibility of lift blockages due to a product falling on top of the ceiling (position 1 of the movable wall) is eliminated.
The possibility of blocking the lift due to interference of the product with the rest of the mechanisms (position 3 of the movable wall) is eliminated.
The loss of cold is limited each time a product is delivered (position 2 of the movable wall).
Greater storage capacity in the storage trays due to the reduced size of the lift by eliminating the ceiling in positions 1 and 3 of the movable wall.
Greater storage capacity in the storage trays by being able to programme the position of the lift with respect to the upper storage tray according to position 3 of the movable wall.
Possibility of selling larger products since they do not have to be rotated in order to be removed from the machine in the delivery lift in a preferred embodiment of product collection door measurement equal to the height measurement of the lift itself.
Possibility of selling several heavy products from one same tray by selectively activating the blockage of the lift, only limiting the vertical movement.
Possibility of making different machines with different sized collection doors without investing in moulds.
Possibility of being able to select for each tray or each product the positioning height of the lift with respect to the tray, modifying the position of the storage tray detection means and therefore softening shocks depending on the fragility of the same.

### DESCRIPTION OF THE FIGURES

To complement the description that has been carried out and to better understand the features of the invention according to a preferred practical embodiment thereof, a set of drawings is attached as an integral part of said description in which, for illustrative and non-limiting purposes of the scope of the invention, the following is shown:

FIG. 1 shows an automatic vending machine according to the present invention comprising a lift according to the present invention, with the product collection door closed.

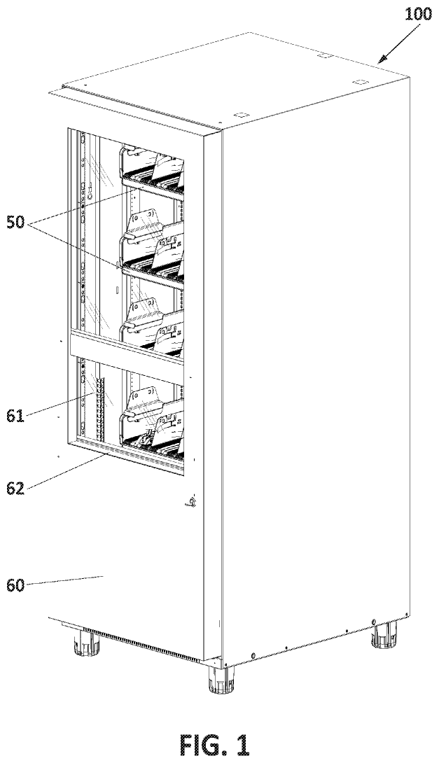

FIG. 2 shows the first position of the movable wall in the lift.

FIG. 3 shows the second position of the movable wall in the lift.

FIG. 4 shows the third position of the movable wall in the lift.

FIG. 5 shows a perspective view of the movable wall of the lift of the present invention.

FIG. 6 shows a perspective view of the lift of the present invention with the movable wall in the second position.

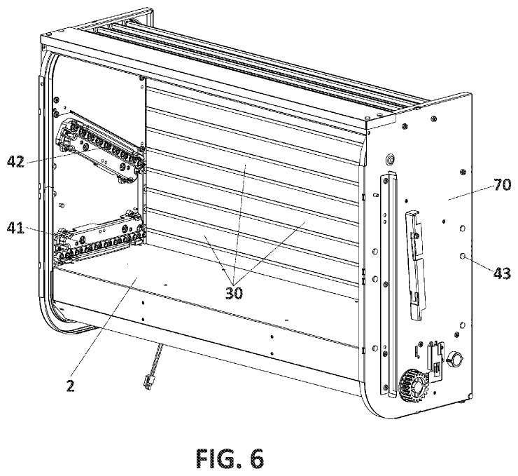

FIG. 7 shows a perspective view of the blocking means configured to block the closure of the product collection door of the machine where the lift is arranged.

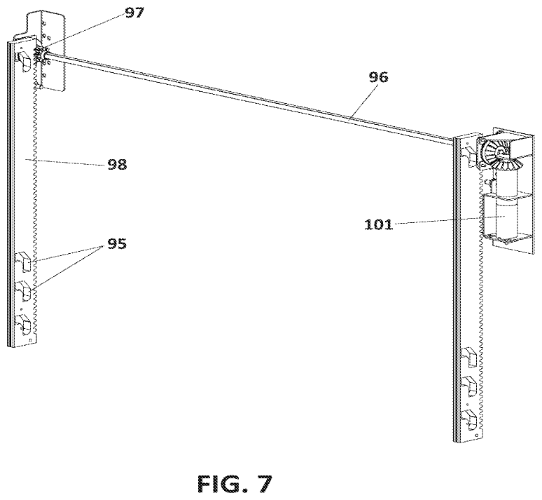

FIG. 8 shows a perspective view of the guiding means of the product collection door.

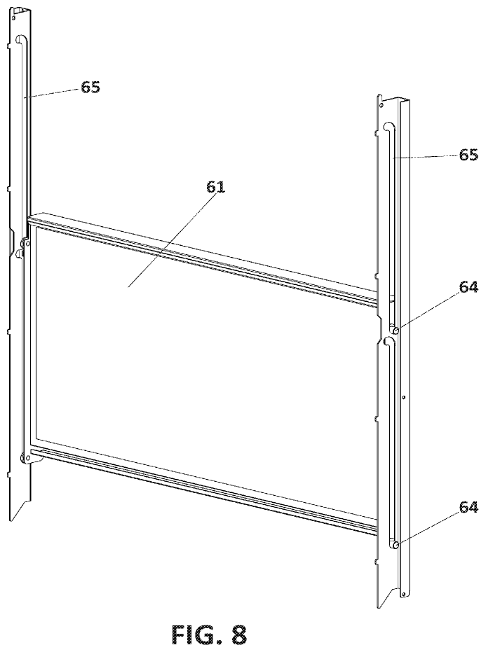

FIG. 9 shows an automatic vending machine according to the present invention comprising a lift according to the present invention, with the product collection door open.

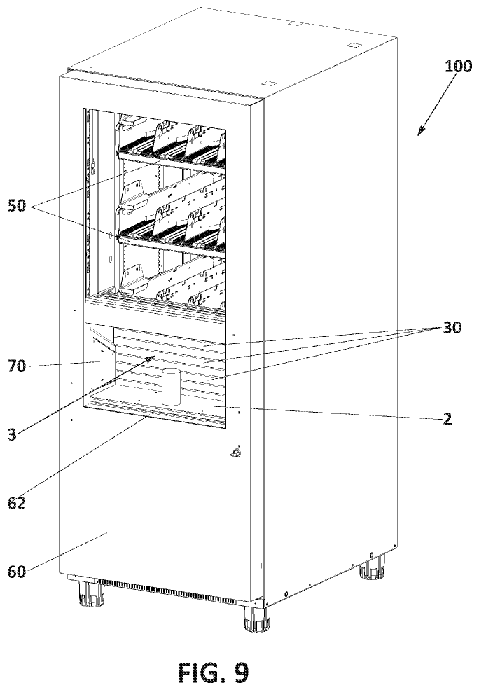

### PREFERRED EMBODIMENT OF THE INVENTION

The automatic vending machine (100) lift (1) of the present invention will be described below in detail, wherein the machine (100) comprises a set of storage trays (50) arranged at different heights where the products (40) to be dispensed are arranged and a front wall (60) that comprises a product collection door (61) comprising a lower edge (62), and wherein the lift (1) comprises:
a platform (2) for collecting the products (40) coming from the storage trays (50), and
a movable wall (3) configured to be positioned at least partially between:
   a first position (P1) in which the movable wall (3), in use, allows a product (40) to pass from a storage tray (50) to the product (40) collection platform (2), and
   a second position (P2) in which the movable wall (3), in use, allows the product (40) to pass from the product (40) collection platform (2) to the outside of the machine (100), and blocks access to at least the storage trays (50) from inside the lift (1).

The movable wall (3) of the lift (1) is also configured to be positioned in a third position (P3) in which the movable wall (3), in use, at least partially separates the inside the lift (1) from the storage trays (50) and from the front wall (60) of the machine, to thus prevent the product (40) arranged on the product collection platform (2) of the lift (1) from colliding with the other products (40) stored on the trays (50) and with the front wall of the machine (60).

The lift (1) is of the internal type with a configuration that makes it possible to optimise the storage space and handle the products (40) in a more comfortable way, positioning itself at the height of the storage trays (50) to collect the products (40) and take them to the delivery point through a product collection door (61) that can be opaque or transparent, isolated or not, depending on the preservation needs of the products (40) stored therein, and therefore its construction will be made up of glass with an air chamber and aesthetic finishes such as transparent silicone inserts or opaque sheet metal doors with insulation therein.

The movable wall (3) is a movable wall (3) made of slats (30) in this exemplary embodiment.

The product (40) collection platform (2) is parallel to the storage trays (50) and to the lower edge (62) of the product collection door (61).

The lift (1) further comprises two side walls (70) that extend above and below the product (40) collection platform (2) on which movement guides (71) are arranged along which the movable wall (3) made of slats (30) joined together moves selectively, allowing a straight or curved wall or both to be formed on both sides of the lift, that is, on the one closest to the product collection door (61) or on the one closest to the storage trays (50), as needed. The displacement guides (71) arranged on the two side walls (70) of the lift (1) allow side ends (31) of the movable slats (30) of the movable wall (3) to move therein.

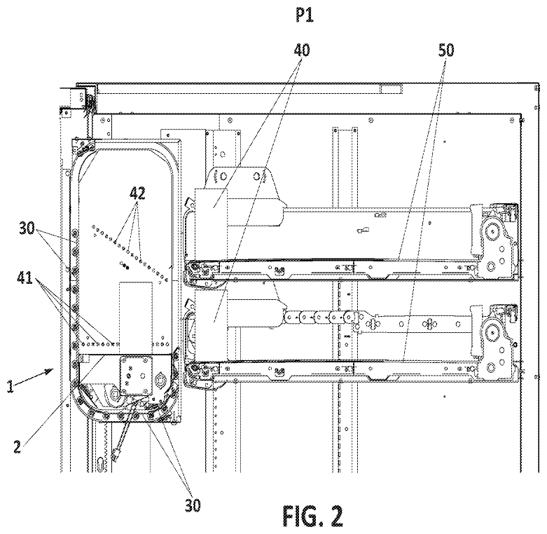

When the lift (1) is facing a product storage tray (50) for dispensing said product (40) from the storage tray (50) to the lift (1), the movable wall (3) is arranged in the first position (P1), shown in FIG. 2, in which the movable wall (3), in use, allows a product (40) to pass from a storage tray (50) to the product (40) collection platform (2), where in this embodiment, the movable slats (30) are positioned forming a “U” with two vertical walls of different heights with respect to the product (40) collection platform (2), one higher than the other, so that the wall facing the storage tray (50) is as low as possible, to reduce the fall distance of the product (40) from the storage tray (50) to the product (40) collection platform (2) of the lift (1). The dispensing of the product (1) from the storage tray (50) to the lift (1) would occur in this open U-shaped configuration and therefore without the limitations entailed by having a ceiling in the lift (1). When high-value products (1) are dispensed, the lift can comprise a camera to record the complete dispensing and record the sequence that serves as proof of a customer complaint about the failure of a sale.

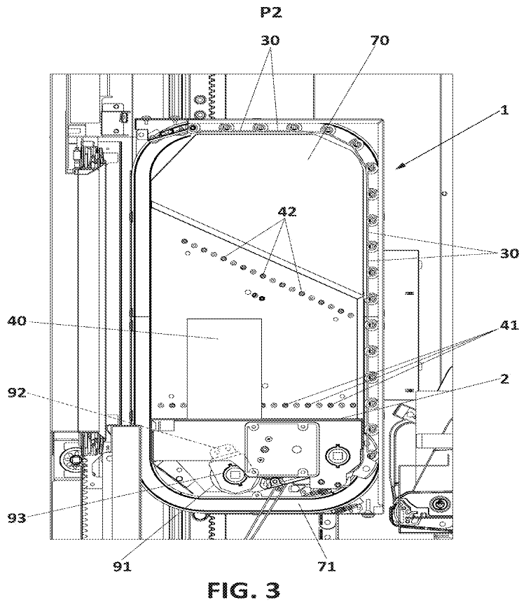

When the lift (1) is facing the product collection door (61), the movable wall (3) is arranged in the second position (P2), shown in FIG. 3, in which the movable wall (3), in use, allows the product (40) to pass from the product (40) collection platform (2) to the outside of the machine (100), and blocks access to at least the storage trays (50) from inside the lift (1), where in this embodiment, the movable slats (30) are positioned on the side closest to the storage trays (50), configuring in this exemplary embodiment a vertical wall and also a ceiling that closes access to the storage area before opening the product collection door (61), which will give the user access to only the lift (1) to collect their product (40) and at the same time prevents losses of cold when said product collection door (61) is opened. In this configuration, the product (40) collection platform (2) of the lift (1) is slightly raised with respect to the lower edge (62) of a perimeter frame of the collection door (61), and therefore to remove the product (40) it is enough to slide it outwards, leaving the product (40) visible at all times when the product collection door (61) is opened.

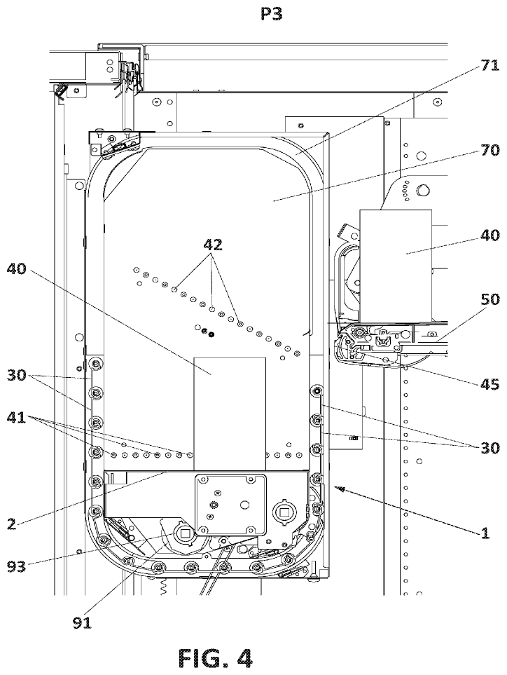

When the lift (1) is moving from the storage trays (50) to the collection door (61), once it has collected a product (40) from the storage trays (50), the movable wall (3) is arranged in the third position (P3), shown in FIG. 4, where in this embodiment, the movable slats (30) are positioned forming a “U” with walls essentially equal in height with respect to the product (40) collection platform (2), before performing the upward or downward movement and thus guaranteeing that the product (40) of the lift cannot collide with the products (40) stored on the storage trays (50) nor with the mechanisms of the opposite face, that is, of the front wall (60) of the machine. This position of the movable wall (3) can be maintained when the lift moves from the collection door (61), once a product (40) has been delivered to the storage trays (50) for a new collection, or from an intermediate position between these two positions to any of them.

The movement of the movable wall (3) made of movable slats (30) to reach any of the three possible positions (P1, P2, P3) or configurations mentioned can be carried out with the product (40) already located on the product collection platform (2) of the lift, since the movable wall (3) made of movable slats (30) moves below this product collection platform (2) without coming into contact with the product (40) that is supported on the platform of the lift only being limited laterally by the walls of the “U” that make up the movable slats (30).

The lift (1) comprises a control system (not shown) configured to control the elements that will be described below and that allow moving and controlling the position of the movable slats (30) of the movable wall (3).

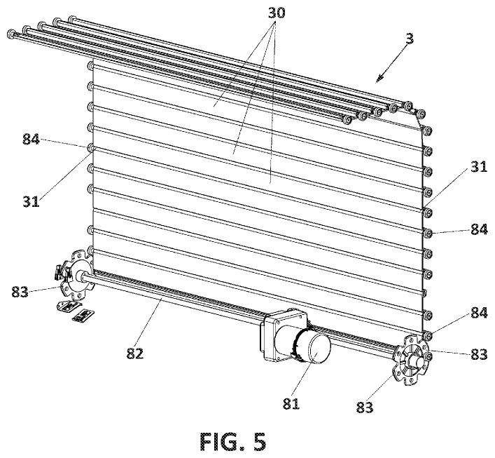

First drive means or a first motor (81), shown in FIG. 5, transform a circular movement of said first motor (81) into a linear movement of the movable wall (3) made of the movable slats (30), through of a first pull bar (82) that extends from the first motor (81) to the side walls (70) of the lift (1), wherein pinions (83) are fitted that engage with cylindrical wheels (84) that are inserted into the side ends (31) of the movable slats (30) of the movable wall (3) and that move inside the guides (71). These guides (71) run along the perimeter of the edges of the side walls (70) of the lift (1) and have a quadrangular shape with very large rotation radii to facilitate the trajectory of the movable wall (3) and be able to reach the different positions (P1, P2, P3) or configurations mentioned above.

The cylindrical wheels (84) that are inserted into the sides (31) of the movable slats (30) of the movable wall (3) have two different diameters. The one closest to the movable wall (3) made of movable slats (30) is the smallest and on it the pinion (83) of the first pull bar (82) engages and the second has a larger diameter, responsible for carrying the movable slats (30) along the displacement guides (71). The side area of this wheel generated by the difference in diameters is used to generate a side stop with an edge that surrounds the entire displacement guide (71), so that it limits the different cylindrical wheels (84) of the blind from leaving their guide during an act of vandalism, preventing theft.

The lift (1) comprises second drive means or a second motor (91) below the product collection platform (2) of the lift, positioned in the centre of the same in this embodiment and responsible for transmitting the circular movement with the help of two second pull bars (92) to the side walls (70) of the lift (1), wherein rotation bushings (93) are positioned fixed on the side walls (70) and on which they rotate, as a bearing integral with the second pull bars (92), pinions (not shown) that engage with racks (not shown) arranged on each side of the machine, converting the circular movement into vertical movement of the lift (1) with respect to the machine.

The lift comprises blocking means or a third motor configured to block and unblock the first drive means (81) and/or the second drive means (91), thus being able to independently or jointly block/unblock the movable wall (3) and the upward and downward movement of the lift (1) itself. This third motor selectively manages the blockages of the first and second pull bars (82, 92), being able to block the movement of the lift (1) vertically, leaving the two systems blocked, or both systems unblocked.

The lift (1) comprises first detection means (41) for detecting the presence of the product on the product collection platform, preferably a first row of photocells, which makes it possible to determine that the product (40) has reached the product collection platform (2) of the lift and that it is located on the same, whereby the extractor performing the dispensing can be controlled, for example by stopping it, and furthermore, when the product collection door (61) is open during removal by the user, it allows checking until the moment the product (40) is on the product collection platform (2), to proceed to close the product collection door (61) and thus end the sale. These first detection means (41) for detecting the presence of the product on the product collection platform or first row of photocells are arranged in a horizontal position adjacent to the product collection platform (2) of the lift.

The lift (1) comprises second detection means (42) for detecting the presence of the product on the product collection platform, preferably a second row of photocells, which makes it possible to determine whether the product (40), during dispensing from the storage tray (50), has fallen on the product collection platform (2) of the lift, whereby the extractor performing the dispensing can be controlled, for example by stopping it, and makes it possible to determine whether the product is still visible by the second detection means (42), whether the product is large in size and whether it is impossible to perform multiple dispensing, or whether the product is not visible by the second detection means (42), whether the product is small in size and whether it is possible to perform multiple dispensing without moving the lift to the product collection door. These second detection means (42) for detecting the presence of the product on the product collection platform or second row of photocells are preferably arranged at a higher height than the first row of photocells, and inclined towards the product storage trays (50) with respect to the collection platform (2). Furthermore, these second detection means (42) for detecting the presence of the product on the product collection platform (2) or second row of photocells make it possible to detect sales from any storage tray (50), but especially from the upper tray, since using this second row of photocells means the lift (1) must be positioned lower with respect to the upper tray of the installation, allowing the last highest tray to be placed inside the machine without the lift interfering with the ceiling, which means having a larger storage area in the machine.

Optionally, the machine comprises detection means (45) arranged on each of the storage trays (50), which detect the position of third detection means of the lift (43), to determine that the lift is in the desired position of the storage trays (50). In order for the lift (1) to be positioned at a certain height with respect to the storage trays (50), the lift comprises two side photocells (43) that are positioned on the side walls (70) of the lift at different heights and that are directed towards detection means (45) of the machine or photodiode present in each storage tray (50), so that a different positioning of the lift (1) is established with each of them, being able to choose the height of the lift (1) at which each product (40) must be dispensed for each product (1) or for each storage tray (50). Thus, the lift can be facing the storage tray (50) in the first position (P1) of the movable wall (3), in which the fall of the products to the lift is minimised, or in the third position (P3) of the movable wall (3), in which the height from the product (40) collection platform (2) to the storage tray (50) is greater, since if the product is not delicate and can receive more impact, in the case of the last tray (50) (the highest), it is possible to put it higher and therefore increase the useful storage area.

In short, when a product is dispensed from the storage tray (50) to the lift (1) and before moving vertically towards the delivery point, the movable wall (3) made of movable slats (30) moves until it reaches the third position (P3) or U-shaped configuration to prevent the products (1) that are inside the lift (1) from interfering laterally in the movement until it reaches the delivery point, at which time the blocking means or third motor of the lift (1) are activated, configured to block the first drive means (81) and the second drive means (91), thus blocking both the movable wall (3) and the upward and downward movement of the lift (1) itself.

The machine further comprises blocking means (101) configured to block the closure of the product collection door (61), preferably a worm-type motor (101) or motor with high gear ratio, constituting a self-blocking system in itself. Also due to the presence of the first detection means (41) in the lift, the presence of any object or part of the user's body, such as a hand, will be detected and the blocking means (101) will block the rise of the product collection door (61) until the first detection means (41) cease to detect said object or part of the user's body.

The collection door (61) in its rest state is closed and blocked by the worm-type motor (101) or motor with high gear ratio, where the collection door (61) is narrower than the lift (1) so that in its horizontal movement towards the lift the collection door (61) is housed therein, occupying the front gap left by the lift between its side walls (70) when the movable wall (3) made of movable slats (30) reaches the second position or configuration, and lowers (the collection door (61)) in that same position until reaching the open position, at which time the products (40) from the lift can be dragged along the surface of the product (40) collection platform (2), passing over the product collection door (61) that has covered the gap left free by the movable wall (3) made of movable slats (30).

Both the horizontal and vertical movement of the collection door (61) is carried out by the pull of the worm-type motor (101) or motor with high gear ratio, integral with a pull bar (96) that extends to both ends and ends in two pinions (97) integral with said pull bar (96), engaging with two racks (98), transforming the rotary movement of the motor (95) into linear movement.

The product collection door (61) has at each end two pivots (64) that move along two side guides (65) integral with the front wall (60) of the machine and have an inverted L-shape, which cross it and are dragged by the aforementioned racks (98) providing the product collection door (61) with a coordinated movement by the pull bar (96) at both ends of the product collection door (61), both vertically and horizontally. Its final open and closed positions are controlled with a photocell barrier (not shown) at each end of the path of one of the side guides (65).

The racks (98) can have several L-shaped housings (95) to drag the pivots (64) of the product collection door (61) and cause, together with the side guides (65), horizontal movements and subsequent vertical movements of said door. In this embodiment, the rack (98) has at least two L-shaped housings, preferably four, to be able to form machines with different product collection door (61) heights since the size of the products to be dispensed is limited by the size of the lift and subsequently by the size of the product collection door (61). In one of its embodiments, the height dimension of the door is equivalent to the height dimension of the lift itself, obtaining a machine capable of dispensing the largest possible size, since in this preferred embodiment the products do not have to be rotated to be extracted from the machine through the product collection door (61). For example, a lift with a total height of 400 mm compared to one with a total height of 500 mm would have a useful storage tray (50) placement area with a height reduced by 200 mm compared to the machine with a 500 mm lift, since it is reduced by multiplying the height difference by two.

1. An automatic vending machine lift, wherein the machine comprises a set of storage trays arranged at different heights where the products to be dispensed are arranged and a front wall that comprises a product collection door comprising a lower edge, wherein the lift comprises:
a platform for collecting the products coming from the storage trays, and
a movable wall configured to be positioned at least partially between:
a first position in which the movable wall, allows a product to pass from a storage tray to the product collection platform, and
a second position in which the movable wall, allows the product to pass from the product collection platform to the outside of the machine, and blocks access to at least the storage trays from inside the lift.

2. The lift of claim 1, wherein the movable wall is also configured to be positioned in a third position in which the movable wall, at least partially separates the inside of the lift from the storage trays and from the front wall of the machine.

3. The lift according of claim 1, wherein the movable wall is configured, in the first position to separate the lift from the front wall of the machine.

4. The lift of claim 1, wherein the movable wall is configured, in the second position, to block an access to the inside of the machine through the upper part of the lift.

5. The lift of claim 2, wherein the third position of the movable wall is an intermediate position between the first position and the second position.

6. The lift of claim 1, wherein the movable wall can be moved from the first position to the second position, and/or vice versa, that is, from the second position to the first position below the product collection platform.

7. The lift of claim 6, comprising a first actuator configured to move the movable wall at least between the first position and the second position, and/or vice versa.

8. The lift of claim 7, comprising a second actuator configured to move the lift in an upward and downward direction with respect to the storage trays.

9. The lift of claim 8, comprising a blocker configured to block and unblock the first actuator and/or the second actuator, thus being able to independently or jointly block/unblock the movable wall and the upward and downward movement of the lift.

10. The lift of claim 1, comprising a first detector for detecting the presence of the product on the product collection platform and arranged in a horizontal position adjacent to the product collection platform of the lift.

11. The lift of claim 1, comprising a second detector for detecting the presence of the product on the product collection platform and inclined towards the product storage trays with respect to the product collection platform.

12. The lift of claim 1, wherein the movable wall is a movable wall made of slats joined together.

13. An automatic vending machine comprising a set of storage trays arranged at different heights where the products to be dispensed are arranged and a front wall that comprises a product collection door comprising a lower edge, and a lift comprising:
a platform for collecting the products coming from the storage trays, and
a movable wall configured to be positioned at least partially between:
a first position in which the movable wall allows a product to pass from a storage tray to the product collection platform, and
a second position in which the movable wall allows the product to pass from the product collection platform to the outside of the machine, and blocks access to at least the storage trays from inside the lift.

14. The automatic vending machine of claim 13, wherein the product collection platform is arranged at the same height or above the lower edge of the product collection door in the second position of the movable wall.

15. The automatic vending machine of claim 13, wherein the product collection door can be moved vertically.
